(19) United States
(12) Patent Application Publication
(10) Pub. No.: US 2007/0036041 A1
(43) Pub. Date: Feb. 15, 2007

(54) Actuator of optical pickup head with horizontally arranged magnetic filed generator and coil device

(75) Inventor: Pei-Ching Kuo, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/480,871

(22) Filed: Jul. 6, 2006

(30) Foreign Application Priority Data
Aug. 12, 2005 (TW) 94127644

(51) Int. Cl. G11B 11/00

(52) U.S. Cl. 369/13.17

(57) ABSTRACT

An actuator of an optical pickup head for accessing data on a disk includes an object-lens holder, a magnetic field generator and a coil device. The object-lens holder carries an object lens. The magnetic field generator generates a first magnetic field perpendicular to a surface of the disk and a second magnetic field parallel to the surface of the disk. The coil device is horizontally disposed at one side of the object-lens holder. The coil device includes a tracking coil and focusing coil. The tracking coil receives a first current and generates a first force for moving the object-lens holder along a tracking direction according to the first magnetic field. The focusing coil receives a second current and generates a second force for moving the object-lens holder along a focusing direction according to the second magnetic field. The focusing coil and tracking coil are disposed at the same level.

This application claims the benefit of Taiwan application Serial No. 94127644, filed Aug. 12, 2005, the subject matter of which is incorporated herein by reference.

### BACKGROUND OF THE INVENTION

1. Field of the Invention

The invention relates in general to an actuator of an optical pickup head, and more particularly to an actuator of an optical pickup head with horizontally arranged magnetic field generator and coil device.

2. Description of the Related Art

Along with information technology progress, most of multimedia products are generated in a form of disk shape. Therefore, the optical pickup head in charge of reading/writing data from/into a disk naturally plays a vital role in today's data accessing technology.

FIG. 1 is a top view of an actuator of a conventional optical pickup head. FIG. 2 is a lateral view of the actuator of FIG. 1. FIG. 3 is a solid view of the actuator of FIG. 1. Referring to FIG. 1˜FIG. 3 at the same time, the actuator of optical pickup head 100 includes an object-lens holder (not shown in the figure), a magnetic filed generator, a focusing coil 132 and tracking coils 134. The object-lens holder is for carrying an object lens, and the object lens focuses the light generated by a semiconductor laser on the disk storing a great deal of data for the optical pickup head to write/read data into/from the disk.

The magnetic field generator includes a first magnet 122 and a second magnet 124. The first magnet 122 and the second magnet 124 are arranged face to face. The surfaces of the first magnet 122 and the second magnet 124 adjacent to the tracking coil 134 have the same polarity, such as N or S. The magnetic field generator generates a magnetic field of a constant direction respectively between the first magnet 122 and the tracking coil 134 and between the second magnet 124 and the tracking coil 134.

The focusing coil 132 is disposed between the first magnet 122 and the second magnet 124 and the central axis of the focusing coil 132 is parallel to the magnetic surfaces of the first magnet 122 and the second magnet 124. When the focusing coil 132 is inputted by a second current, the focusing coil 132 generates a second force according to the second current and a second magnetic field to move the object-lens holder along a focusing direction.

The tracking coils 134 are respectively disposed between the focusing coil 132 and the first magnet 122 and between the focusing coil 132 and the second magnet 124, and the central axis of the tracking coil 134 is perpendicular to the magnetic surfaces of the first magnet 122 and the second magnet 124. When the tracking coils 134 are inputted by a first current, the tracking coil 134 generates a first force according to the first current and a first magnetic field to move the object-lens holder along a tracking direction.

However, in the actuator of the conventional optical pickup head, in order to generate the first force and the second force to respectively drive the object-lens holder to move along the focusing direction and the tracking direction, the focusing coil and the tracking coil need to be perpendicular to each other. As a result, the winding process of the focusing coil and the tracking coil becomes very complicated and difficult, and the manufacturing time and production cost are also increased. Besides, the volume and thickness of the actuator cannot be effectively reduced, thereby limiting the application of the optical pickup head in the thin-type disk drive and small form factor optical disk drive (SFFO).

### SUMMARY OF THE INVENTION

It is therefore an object of the invention to provide an actuator of optical pickup head with horizontally arranged magnetic field generator and coil device. The magnetic field generator forms different polarities on the same magnetic surface to generate two magnetic fields perpendicular to each other, which in turn provide the required first force and second force for the object-lens holder to move along the focusing direction and the tracking direction. Consequently, the tracking coil and the focusing coil can be integrated onto the same plane of a coil device to effectively reduce the volume and thickness of the actuator of the optical pickup head.

The invention achieves the above-identified object by providing an actuator of an optical pickup head for reading/writing data from/into a disk. The actuator includes an object-lens holder, a magnetic field generator and a coil device. The object-lens holder is for carrying an object lens. The magnetic field generator is for generating a first magnetic field perpendicular to a surface of the disk and a second magnetic field parallel to the surface of the disk. The coil device is horizontally disposed at one side of the object-lens holder. The coil device includes a tracking coil and a focusing coil. The tracking coil is for receiving a first current and generating a first force for moving the object-lens holder along a tracking direction according to the first magnetic field. The focusing coil is for receiving a second current and generating a second force for moving the object-lens holder along a focusing direction according to the second magnetic field, wherein the focusing coil and the tracking coil are disposed at the same level.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a top view of an actuator of a conventional optical pickup head.

FIG. 2 is a lateral view of the actuator of FIG. 1.

FIG. 3 is a solid view of the actuator of FIG. 1.

FIG. 4 is a lateral view of the actuator of an optical pickup head according to the first embodiment of the invention.

FIG. 5 is a top-view perspective drawing of the actuator of an optical pickup head according to the first embodiment of the invention.

FIG. 6 is a schematic diagram of the tracking coil inputted by the first current.

FIG. 7 is a schematic diagram of the focusing coil inputted by a second current.

FIG. 8 is a lateral view of the actuator of an optical pickup head according to the second embodiment of the invention.

FIG. 9 is a top-view perspective drawing of the actuator of an optical pickup head according to the second embodiment of the invention.

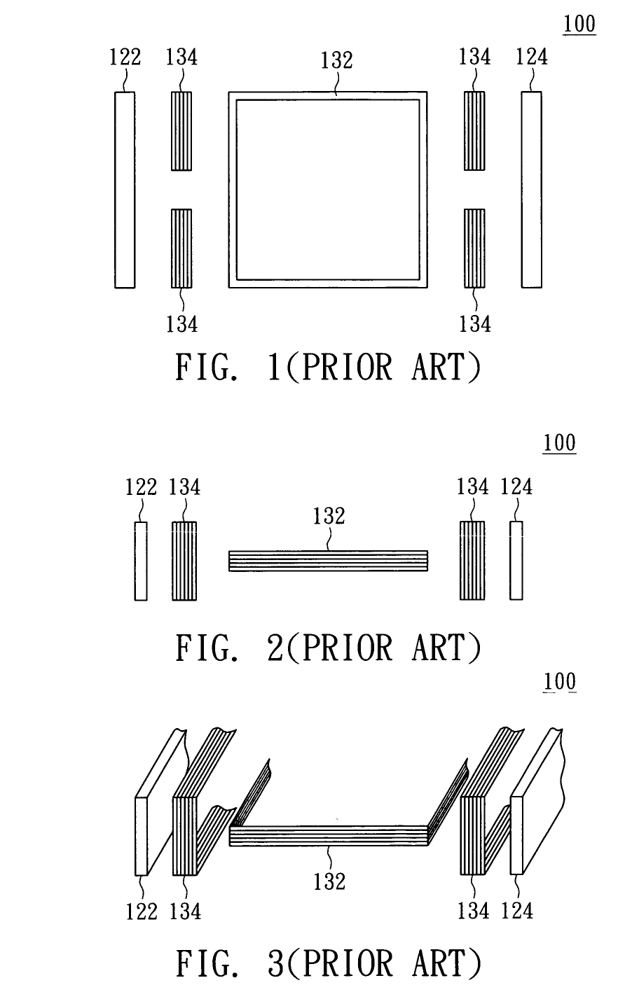

### DETAILED DESCRIPTION OF THE INVENTION

Along with technical progress, an increasing number of electronic devices tend to be designed thin and small in order to improve their market competitiveness. This tendency is especially obvious in the optical pickup head of an optical disk drive. The invention integrates the tracking coil and the focusing coil at the same surface of the coil device and designs different polarities on the same magnetic surface of a magnetic field generator. As a result, the coil device and the magnetic field generator arranged horizontally can respectively move the object-lens holder along the focusing direction and the tracking direction. The volume and thickness of the actuator of optical pickup head can be reduced due to horizontal arrangement of the magnetic field generator and coil device.

### Embodiment One

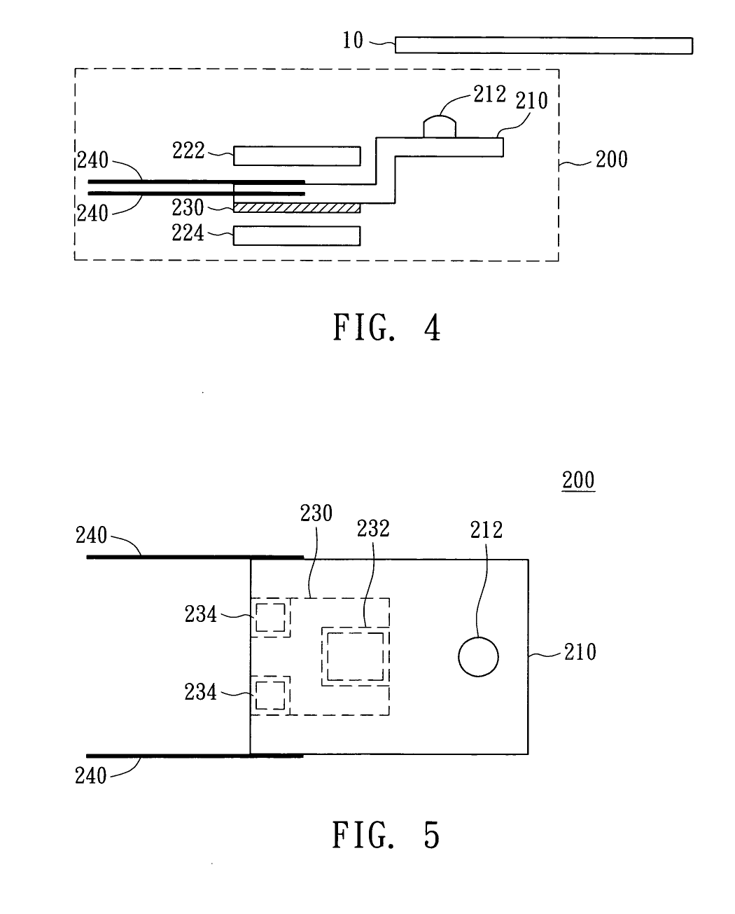

FIG. 4 is a lateral view of the actuator of an optical pickup head according to the first embodiment of the invention. FIG. 5 is a top-view perspective drawing of the actuator of an optical pickup head according to the first embodiment of the invention. Referring to FIG. 4 and FIG. 5 at the same time, the actuator 200 of an optical pickup head is for reading/writing data from/into data tracks of a disk 10. The actuator 200 includes an object-lens holder 210, a magnetic field generator and a coil device 230. The object-lens holder 210 is suspended at one end. The object-lens holder 210 is for carrying an object lens 212. The object-lens holder 210 is suspended by a suspension device 240, and the suspension device 240 is a metal line or an elastic plate for instance.

The magnetic field generator generates a first magnetic field perpendicular to the surface of the disk 10, and a second magnetic field in parallel to the surface of the disk 10. The magnetic field generator includes a first magnet 222 and a second magnet 224 for instance. The first magnet 222 is horizontally disposed above the object-lens holder while the second magnet 224 is horizontally disposed under the object-lens holder corresponding to the first magnet 222.

The coil device 230 is horizontally disposed at one side of the object-lens holder and the coil device 230 is made by windings, a printed circuit board or electroplating for instance. The coil device 230 includes a focusing coil 232 and a tracking coil 234. The focusing coil 232 and the tracking coil 234 are coils of a rectangle loop for instance. When the focusing coil 232 is inputted by a second current, the actuator 200 generates a second force to move the object-lens holder 210 along a focusing direction according to the second current and the second magnetic field. When the tracking coil 234 is inputted by a first current, the actuator 200 generates a first force to move the object-lens holder along a tracking direction according to the first current and the first magnetic field. The tracking coil 234 and the focusing coil 232 are disposed at the same level.

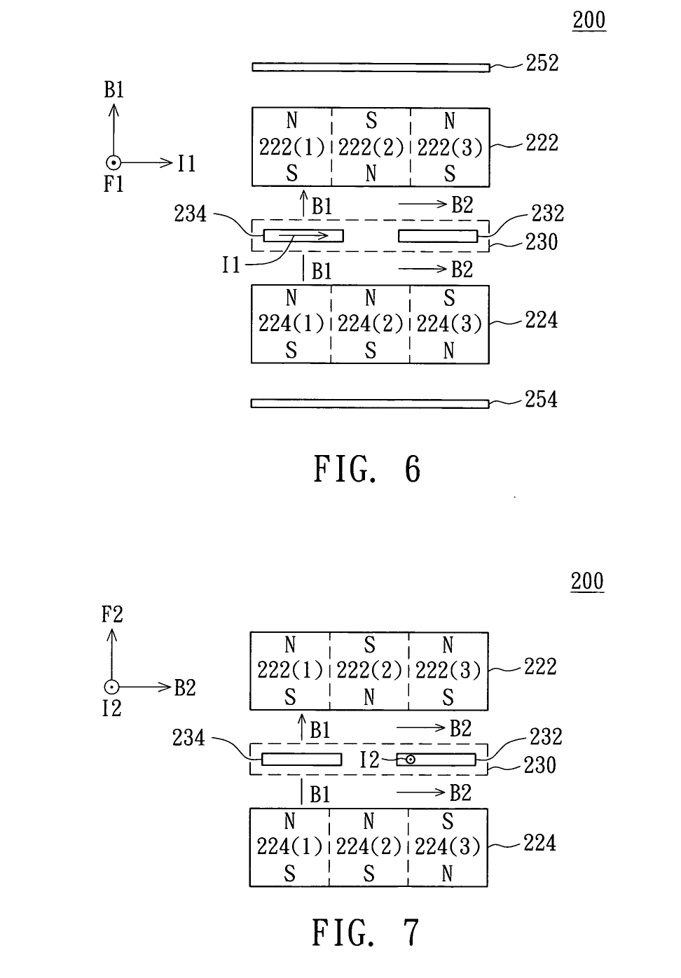

Referring to FIG. 6, a schematic diagram of the tracking coil inputted by the first current is shown. Under the structure of the coil device 230 and the magnetic field generator horizontally arranged on a vertical line. The first magnetic field B1 and the second magnetic field B2 perpendicular to each other can be generated by using the first magnet 222 and the second magnet 224 of multi-polarity. Accordingly, the focusing coil 232 and the tracking coil 234 can generate the first force and the second force perpendicular to each other.

The first magnet 222 and the second magnet 224 respectively include a number of magnetic areas. The magnetic areas of the first magnet 222 and the second magnet 224 have different polarities according to their positions relative to the focusing coil 232 and the tracking coil 234. For example, when the coil device 230 is designed as in FIG. 5, the magnetic areas of the first magnet 222 are respectively a first magnetic area 222(1), a second magnetic area 222(2) and a third magnetic area 222(3). The magnetic areas of the second magnet are respectively a first magnetic area 224 (1), a second magnetic area 224(2) and a third magnetic area 224(3).

The magnetic surfaces of the first magnetic area 222(1) and the third magnetic area 222(3) of the first magnet 222 and the third magnetic area 224(3) of the second magnet 224, which are adjacent to the coil device 230, are designed to have a first polarity, such as S. The magnetic surfaces of the second magnetic area 222(2) of the first magnet 222 and the first magnetic area 224(1) and the second magnetic area 224(2) of the second magnet 224, which are adjacent to the coil device 230, are designed to have a second polarity, such as N.

Through the above-mentioned polarity arrangement, the first magnetic field B1 vertical to the surface of the disk 10 is formed between the first magnetic area 222(1) of the first magnet 222 and the first magnetic area 224(1) of the second magnet 224 and the second magnetic field B2 parallel to the surface of the disk 10 is formed between the second magnetic area 222(2) and the third magnetic area 222(3) of the first magnet 222 and between the second magnetic area 224(2) and the third magnetic area 224(3) of the second magnet 224. A first yoke 252 can be disposed above the first magnet 222 and a second yoke 254 can be disposed under the second magnet 224 in order to increase the magnetic intensity of the first magnetic field B1 and the second magnetic field B2 in the actuator 200.

The object-lens holder 210 is connected to the suspension device 240 to have a suspension state. As a result, when the tracking coil 234 is inputted by a first current I1, the first force F1 generated by the tracking coil 234 according to the first current I1 and the first magnetic field B1 can move the object-lens holder 210 along a tracking direction.

Referring to FIG. 7, a schematic diagram of the focusing coil inputted by a second current is shown. Similarly, when the focusing coil 232 is inputted by a second current I2, the second force F2 generated by the focusing coil 232 according to the second current I2 and the second magnetic field B2 can move the object-lens holder 210 along a focusing direction vertical to the surface of the disk 10. The focusing direction is also vertical to the tracking direction mentioned above.

The actuator 200 of an optical pickup head respectively moves the object-lens holder 210 along the tracking direction or the focusing direction by using the horizontally arranged magnetic field generator and coil device 230 to read/write data from/into each data track of the disk 10. The magnetic field generator and coil device are not limited to those mentioned in the first embodiment. The effect of the invention can be achieved by adjusting the number of magnetic areas of the magnetic field generator and the winding number of the coil device.

### Embodiment Two

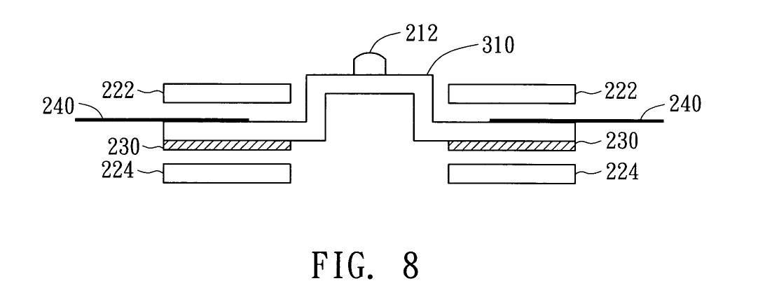

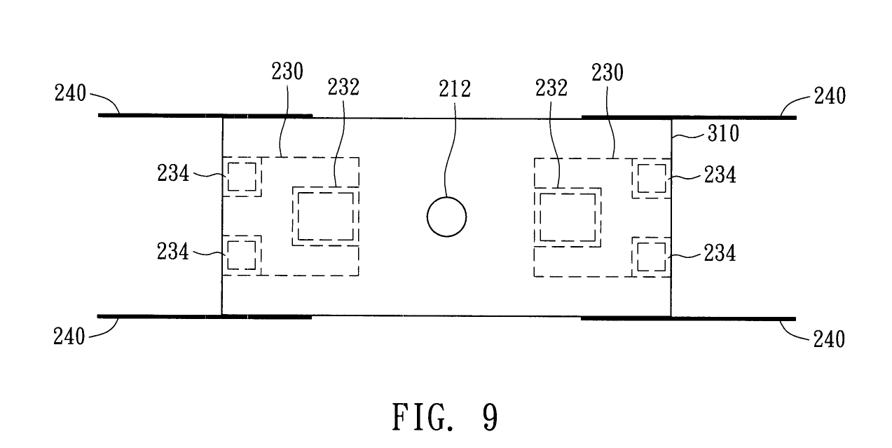

FIG. 8 is a lateral view of the actuator of an optical pickup head according to the second embodiment of the invention. FIG. 9 is a top-view perspective drawing of the actuator of an optical pickup head according to the second embodiment of the invention. Referring to FIG. 8 and FIG. 9 at the same time, the object-lens holder of the invention is not limited to that object-lens holder of a suspension form as shown in FIG. 4. When the appearance of the object-lens holder is changed, the coil device, the magnetic field generator and the suspension device can be disposed at other positions of the actuator 200 accordingly.

For example, when the object-lens holder is suspended at two ends as shown in FIG. 8, the coil device 230, the first magnet 222, the second magnet 224, the first yoke 252, the second yoke 254 and the suspension device 240 of the first embodiment can be symmetrically disposed at two sides of the object-lens holder in correspondence with the design of the object-lens holder.

In the actuator of optical pickup head with horizontally arranged magnetic field generator and coil device disclosed by the two embodiments of the invention, the tracking coil and the focusing coil are integrated at the same surface of the coil device and the coil device and the magnetic field generator are arranged horizontally. Therefore, the volume and thickness of the actuator of optical pickup head of the invention can be reduced, which is especially applicable to the thin-type disk drive and SFFO.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An actuator of an optical pickup head, for reading/writing data from/into a disk, the actuator comprising:
an object-lens holder, for carrying an object lens;
a magnetic field generator, for generating a first magnetic field perpendicular to a surface of the disk and a second magnetic field parallel to the surface of the disk; and
a coil device, horizontally disposed at one side of the object-lens holder, the coil device comprising:
a tracking coil, for receiving a first current and generating a first force for moving the object-lens holder along a tracking direction according to the first magnetic field; and
a focusing coil, for receiving a second current and generating a second force for moving the object-lens holder along a focusing direction according to the second magnetic field, wherein the focusing coil and the tracking coil are disposed at the same level.

2. The actuator according to claim 1, wherein the focusing direction is perpendicular to the surface of the disk.

3. The actuator according to claim 1, wherein the tracking direction is perpendicular to the focusing direction.

4. The actuator according to claim 1, comprising two coil devices horizontally disposed at two sides of the object-lens holder respectively.

5. The actuator according to claim 1, wherein the coil device is formed by windings.

6. The actuator according to claim 1, wherein the coil device is formed by a printed circuit board.

7. The actuator according to claim 1, wherein the magnetic field generator comprises:
a first magnet, horizontally disposed above the object-lens holder, the first magnet having a first magnetic area, a second magnetic area and a third magnetic area, wherein the magnetic surfaces of the first magnetic area and the third magnetic area adjacent to the coil device have a first polarity and the magnetic surface of the second magnetic area adjacent to the coil device has a second polarity; and
a second magnet, horizontally disposed under the object-lens holder, the second magnet having a first magnetic area, a second magnetic area and a third magnetic area, wherein the magnetic surfaces of the first magnetic area and the second magnetic area adjacent to the coil device has the second polarity and the magnetic surface of the third magnetic area adjacent to the coil device has the first polarity;
wherein the first magnetic field is formed between the first magnetic area of the first magnet and the first magnetic area of the second magnet;
wherein the second magnetic field is formed between the second magnetic area and the third magnetic area of the first magnet and between the second magnetic area and the third magnetic area of the second magnet.

8. The actuator according to claim 1, comprising two magnetic field generators horizontally disposed at two sides of the object-lens holder respectively.

9. The actuator according to claim 1, further comprising a yoke device, wherein the yoke device comprises:
A first yoke, horizontally disposed above the first magnet; and
A second yoke, horizontally disposed under the second magnet.

10. The actuator according to claim 9, comprising two yoke devices horizontally disposed at two sides of the object-lens holder respectively.

11. The actuator according to claim 7, wherein the first magnetic device is a multi-polarity magnet.

12. The actuator according to claim 7, the second magnetic device is a multi-polarity device.

13. The actuator according to claim 1, wherein the disk has a plurality of data tracks and the first force locks the lens to one of the data tracks.

14. The actuator according to claim 1, wherein the coil device and the magnetic field generator are horizontally arranged on a vertical line.

15. The actuator according to claim 1, comprising a suspension device connected to the object-lens holder for suspending the object-lens holder.

16. The actuator according to claim 15, wherein the suspension device is a metal line.

17. The actuator according to claim 15, wherein the suspension device is an elastic plate.

18. The actuator according to claim 1, wherein the tracking coil is a coil of a rectangle loop.

19. The actuator according to claim 1, wherein the focusing coil is a coil of a rectangle loop.
